(19) United States
(12) Patent Application Publication
(10) Pub. No.: US 2003/0222927 A1
(43) Pub. Date: Dec. 4, 2003

(54) Apparatus for forming film member; and method of manufacturing lens, color filter, and organic EL device

(75) Inventor: Minoru Koyama, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/414,211

(22) Filed: Apr. 16, 2003

(30) Foreign Application Priority Data
Apr. 26, 2002 (JP) 2002-125718
Mar. 26, 2003 (JP) 2003-084826

(51) Int. Cl. B41J 2/165

(52) U.S. Cl. 347/2; 347/36

(57) ABSTRACT

In an apparatus for forming a film member on a surface of a workpice, relative scanning is performed between the workpiece and a function liquid droplet ejection head having introduced therein a function liquid such that the function liquid droplet is ejected beyond an edge of the workpiece. The apparatus is made up of a trough-shaped receiving member for receiving the function liquid which is ejected from the function liquid droplet ejection head beyond the edge of the workpiece, and a waste function liquid storing member which is connected by a pipe to a downstream side of the trough-shaped receiving member and which stores therein the function liquid discharged from the trough-shaped receiving member.

### BACKGROUND OF THE INVENTION

1. Field of the Invention

This invention relates to an apparatus for forming a film member (thin film) of a function material on a surface of a workpiece by using a function liquid droplet ejection head, as well as a method of forming a lens, a method of manufacturing a color filter, and a method of manufacturing an organic eletroluminescence (EL) device.

2. Description of Related Art

As a conventional function liquid droplet ejection head, there can be listed an ink jet head in an ink jet printer, or the like. Since the ink jet head can eject minute or very fine ink droplets in the form of dots at a high accuracy, the ink jet head is expected to be applied to the field of manufacturing various components or constituent parts. As an example, an apparatus for forming a film member is being under consideration. The apparatus for forming a film member is to eject a function liquid containing a function material such as a resin, or the like, from a function liquid droplet ejection head so that a film member of the function material is formed on a workpiece.

In this kind of apparatus for forming a film member, in order to form a uniform film member (thin film) over the entire surface of the workpiece, it is necessary to eject the beyond or past the edge (or edges) of the workpiece. It is then preferable to cause the function material that has been ejected beyond the edge to be absorbed by a function material absorbing member. However, in the apparatus for forming a film member for an industrial purpose, a large amount of function material is ejected and, therefore, the absorbing material will no longer be able to absorb the function material. As a result, it becomes necessary to frequently replace the absorbing material. The apparatus for forming a film member using the absorbing material is therefore poor in the ease of performing maintenance and is not efficient.

### SUMMARY OF THE INVENTION

This invention has an advantage of providing an apparatus for forming a film member which is capable of adequately forming a film member to the edge portion of a workpiece and which has an ease with which the maintenance work of the apparatus can be performed; a method of manufacturing a lens; a method of manufacturing a color filter; and a method of manufacturing an organic EL device.

According to one aspect of this invention, there is provided an apparatus for forming a film member, comprising: a first means for ejecting a function liquid droplet beyond an edge of a workpiece by performing relative scanning between the workpiece and a function liquid droplet ejection head having introduced therein a function liquid; a second means for receiving the function liquid ejected beyond the edge of the workpiece; and a third means for storing a waste function liquid discharged from the second means.

According to this invention, there is also provided an apparatus for forming a film member on a surface of a workpice. The apparatus comprises: a first means for performing relative scanning between the workpiece and a function liquid droplet ejection head having introduced therein a function liquid, the scanning being made beyond an edge of the workpiece; a second means for selectively ejecting a function liquid droplet from the function liquid droplet ejection head during scanning by the first means; a third means for receiving the function liquid ejected beyond the edge of the workpiece; and a fourth means for storing a waste function liquid discharged from the second means.

According to another aspect of this invention, there is provided an apparatus for forming a film member on a surface of a workpice, wherein relative scanning is performed between the workpiece and a function liquid droplet ejection head having introduced therein a function liquid such that the function liquid droplet is ejected beyond an edge of the workpiece. The apparatus comprises: a trough-shaped receiving member which receives the function liquid to be ejected from the function liquid droplet ejection head beyond the edge of the workpiece; and a waste function liquid storing member which is connected by a pipe to a downstream side of the trough-shaped receiving member and which stores therein the function liquid discharged from the trough-shaped receiving member.

According to this arrangement, the trough-shaped receiving member prevents the inside of the apparatus from getting stained with the function liquid that has been ejected beyond the edge of the workpiece. Therefore, the workpiece can be coated with the function liquid in the edge portion thereof in the same manner as in the central part of the workpiece. As a result, the function liquid can be ejected uniformly over the entire surface of the workpiece without leaving the workpiece partially uncoated, and the thickness of the film to be coated on the surface of the workpiece can be made uniform. Further, the function liquid that has dropped into the trough-shaped member can be caused to flow down to the waste function liquid storing means. When the waste liquid function storing member has become full of the function liquid stored therein, the waste function liquid storing member may be replaced or only the waste function liquid may be disposed of. The maintenance of the apparatus can therefore be made easily and efficiently. In addition, since the function liquid that has been ejected beyond the edge of the workpiece is cumulatively stored in the waste function liquid storing member, the function liquid in the waste function liquid tank can be used for recycling. Still furthermore, since the function liquid is arranged to be ejected beyond the edge of the workpiece, and since the function liquid that has been ejected beyond the edge of the workpiece is received by the trough-shaped receiving member, the entire surface of the workpiece can be adequately coated with the function liquid as long as the workpice is positioned inside the trough-shaped receiving member. Therefore, it is not required any more to exactly align the mounting position of the workpiece. As a result, a positioning means for precisely or accurately positioning the mounting position of the workpiece is no longer needed, resulting in the simplification of the apparatus. The time required to set the workpiece in position can also be reduced, resulting in an improvement in the workability.

Preferably, the trough-shaped receiving member is formed into a U shape in cross section.

According to this arrangement, the function liquid that has been received by the trough-shaped receiving member flows quickly along the recessed bottom portion of the trough-shaped receiving member, so that the function liquid in the trough-shaped receiving member can be quickly discharged to the waste function liquid storing member.

Preferably, the trough-shaped receiving member is formed into a loop in which an upper open portion of the trough-shaped receiving member faces the edge of the workpiece.

According to this arrangement, since the trough-shaped receiving member is formed into a loop in which the upper open portion of the trough-shaped receiving member faces the edge of the workpiece, it is possible to receive the function liquid that has been ejected beyond the edge of the workpiece in an efficient and space-saving manner.

Preferably, the trough-shaped receiving member has a discharge slope toward a downstream end thereof.

According to this arrangement, due to the discharge slope provided in the trough-shaped receiving member, the function liquid inside the trough-shaped receiving member can be ejected more quickly to the waste function liquid storing member. The slope is preferably in the range of about 1/50 to 1/100.

Preferably, the trough-shaped receiving member is fixed to a work table on which the workpiece is placed.

According to this arrangement, even if the workpiece moves as a result of liquid droplet ejection by the function liquid droplet ejection head, the function liquid that has been ejected beyond the edge of the workpiece can always be efficiently received by the trough-shaped receiving member.

Preferably, the apparatus further comprises a cleaning means which cleans an inside of the trough-shaped receiving member.

According to this arrangement, even if the inside of the trough-shaped receiving member gets stained as a result of drying of the received function liquid, or the like, the stain can be cleaned with the cleaning means. As a result, the dried function liquid will not get clogged or stuck fast to the inside of the trough of the trough-shaped receiving member. It is thus possible to smoothly cause the function liquid to flow downward into the waste function liquid storing member.

Preferably, the cleaning means comprises a cleaning tank which stores therein a cleaning liquid and which is connected by a pipe to an upstream end of the trough-shaped receiving member.

According to this arrangement, the cleaning liquid to clean the trough-shaped receiving member can be stored in the cleaning liquid tank. In addition, since the cleaning liquid tank is connected by the pipe to the upstream side of the trough-shaped receiving member, it is possible to send the cleaning liquid directly to the trough-shaped receiving member, and it is also possible to efficiently send the cleaning liquid from the upstream end of the trough-shaped receiving member to the entire trough-shaped receiving member.

Preferably, the cleaning means further comprises a cleaning liquid discharge pipe which is connected to the cleaning liquid tank and which is laid along an upper inside of the trough-shaped receiving member, and the cleaning liquid discharge pipe has a plurality of discharge holes for discharging the cleaning liquid therethrough.

According to this arrangement, it is possible to send the cleaning liquid in the cleaning liquid tank to the trough-shaped receiving member by means of the cleaning liquid discharge pipe and then to discharge the cleaning liquid out of the ejection holes of the cleaning ejection pipe toward the inside of the trough of the trough-shaped member which is the object to be cleaned. In other words, it is possible to supply the entire regions of the trough-shaped receiving member with the cleaning liquid, whereby the cleaning of the trough-shaped receiving member can be performed well.

Preferably, the cleaning liquid discharge pipe is laid out along an inner upper portion of an outer side wall of the trough-shaped receiving member.

According to this arrangement, since the cleaning liquid discharge pipe is laid out along the inner upper portion of the outer side wall of the trough-shaped receiving member, the inner circumference of the outer side wall of the trough-shaped receiving member can be efficiently cleaned. The inner circumference is the portion to which the function liquid is likely to be dropped.

Preferably, each of the discharge holes discharges the cleaning liquid toward an inner upper portion of an outer side wall of the trough-shaped receiving member.

According to this arrangement, the cleaning liquid is ejected out of the respective discharge holes toward the inner upper portion of the outer side wall of the trough-shaped receiving member. Therefore, the cleaning liquid can be discharged substantially toward the whole of the inner circumference of the trough-shaped receiving member, the inner circumference being the portion that is subjected to the heaviest stain by receiving the function liquid. The function liquid can thus be efficiently washed away by the cleaning liquid.

Preferably, the apparatus further comprises function liquid level detecting means which detects a level of the waste function liquid storing means, and control means which controls discharge operation of the function liquid droplet ejection head, wherein the control means stops the discharge operation of the function liquid droplet ejection head when the function liquid level detecting means detects a fully stored state of the waste liquid storing member.

According to this arrangement, when the function liquid level detecting means has detected the state in which the waste function liquid storing member is filled up with the waste function liquid, the ejection operation of the function liquid droplet ejection head is stopped. Therefore, the waste function liquid stored in the waste function liquid storing member can be prevented from overflowing out of the waste function liquid storing member. Instead of stopping the ejection operation of the function liquid droplet ejection heads immediately after detection of the state in which the waste function liquid storing member is filled up with the waste function liquid, preferably, the ejection operation is stopped after the completion of forming a thin film on the workpiece if the work of the thin film formation is still on a way.

According to another aspect of this invention, there is provided a method of manufacturing a lens for forming a coating film on a surface of the lens by using the above-described apparatus for forming a film member. The method comprises: introducing a translucent coating material, which serves as the function liquid, into the function liquid droplet ejection head; and performing relative scanning between the function liquid droplet ejection head and the surface of the lens, thereby ejecting the coating material to form the coating film. Preferably, the lens is for use with a pair of eyeglasses.

According to this arrangement, the coating film can be easily formed on the surface of the lens without resort to the conventional dipping method. As a result, the wasteful consumption of the coating material in the dipping method, because the coating material is thrown away, can be restricted. In addition, a uniform coating film (hard coating) can be formed on the lens.

Preferably, the lens is made up of a pair of eyeglass-lenses which are set in position on a tray.

According to this arrangement, the eyeglass-lenses can be prevented from being brought into direct contact with an operator or a relevant apparatus. In addition, the coating of a pair of eyeglass-lenses which are sold in a set of two lenses can be performed in the same conditions.

According to another aspect of this invention, there is provided a method of manufacturing a color filter. The color filter is made by arranging filter elements on a substrate, which serves as the workpiece, by using the above-described apparatus for forming a film member. The method comprises: introducing, after the filter element is formed, a translucent coating material, which serves as the function liquid, into the function liquid droplet ejection head; and performing relative scanning between the function liquid droplet ejection head and the substrate, thereby ejecting the coating material to form an overcoat film.

According to still another aspect of this invention, there is provided a method of manufacturing an organic EL device by using the above-described apparatus for forming a film member. The EL device is made by arranging pixels inclusive of EL light emitting layers on a substrate. The method comprises: introducing, after the EL light emitting layers are formed, a liquid electrode material, which serves as the function liquid, into the function liquid droplet ejection head; and performing relative scanning between the function liquid droplet ejection head and the substrate, thereby selectively ejecting the liquid electrode material to form a counter electrode film.

According to the above-described arrangements, by applying the above-described apparatus for forming the film member to the method of manufacturing a color filter and to the method of manufacturing an organic EL device, the overcoat film and the counter electrode film can be efficiently formed.

### BRIEF DESCRIPTION OF THE DRAWINGS

FIG. 1 is a schematic diagram showing the basic arrangement of an apparatus for ejecting liquid droplets in which an apparatus for forming a film member according to this invention is employed;

FIG. 2 is a side view, partly shown in section, around a waste function liquid storing member of the apparatus for ejecting liquid droplets according to this invention;

FIG. 3 is a perspective view showing an outside of the waste function liquid storing member of the liquid droplet ejection apparatus according to this invention;

FIG. 4 is a schematic diagram showing the basic arrangement of the liquid droplet ejection apparatus according to second embodiment of this invention;

FIGS. 5A and 5B show a tray in which FIG. 5A is an external perspective view of the tray and FIG. 5B is a sectional view taken along the line A-A in FIG. 5A;

FIGS. 6A through 6C show waste liquid storing member in which FIG. 6A is a schematic diagram thereof according to a third embodiment, FIG. 6B is a schematic diagram thereof according to a fourth embodiment, and FIG. 6C is a schematic sectional view thereof according to the third embodiment;

FIG. 7 is a sectional view of a liquid crystal display device which is manufactured by the method of manufacturing a color filter according to this invention; and

FIG. 8 is a sectional view of an organic EL device which is manufactured by the manufacturing method according to this invention.

### DETAILED DESCRIPTION OF THE PREFERRED EMBODIMENTS

With reference to the accompanying drawings, a description will now be made about the preferred embodiments of this invention. In a first embodiment, an apparatus for forming a film member according to this invention is applied to an apparatus for ejecting liquid droplets. This apparatus for ejecting liquid droplets may be put to various uses such as for manufacturing a pair of lenses for use in a pair of eyeglasses (hereinafter also referred to as eyeglass-lenses for simplicity). For example, like in the case of coating the eyeglass-lenses with a film member which is made from an ultraviolet light screening agent, a defrosting agent, or the like, a function liquid is ejected from function liquid ejection head (or heads) into which the function liquid is introduced, toward eyeglass-lenses (collectively referred to as a workpiece) each of which is an object to which the function liquid is ejected. A film (hard coat) of the function material is thus formed on the workpiece. The eyeglass-lenses which collectively serve as a workpiece W is circular in plan view having a diameter of about 10 cm. After coating with a function material, the workpiece is cut to a desired shape.

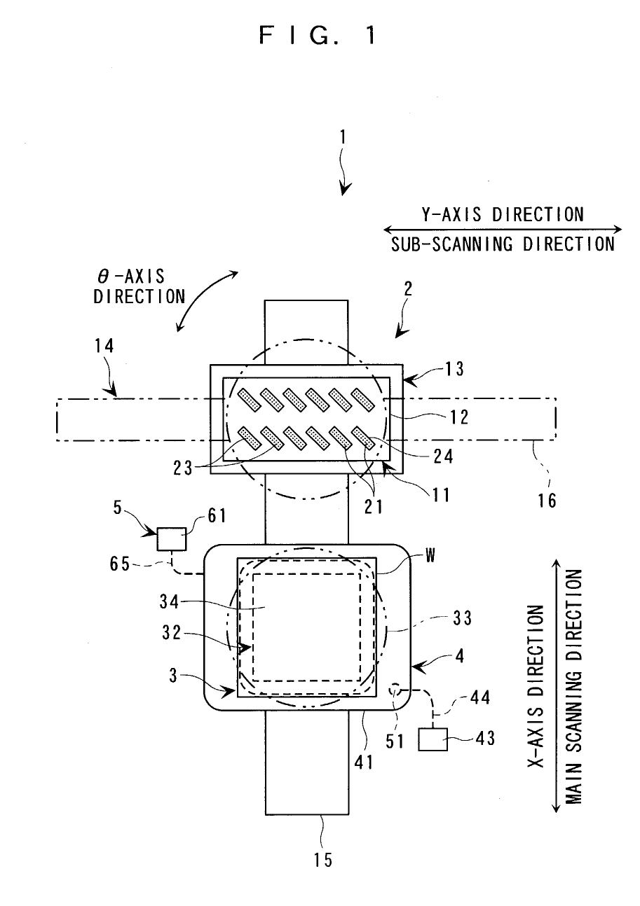

FIG. 1 is a schematic diagram showing a basic arrangement of the liquid droplet ejection apparatus according to one embodiment. As shown therein, the liquid droplet ejection apparatus 1 is made up of: a function liquid droplet ejection device 2 for ejecting the function liquid toward the workpiece W which is the object to which the function liquid is ejected; a mounting device 3 for setting in position the workpiece W on the liquid droplet ejection apparatus 1; a waste function liquid storing device or member 4 for storing the function liquid that has been ejected beyond (or in excess of) the boundary or outer edge of the workpiece W; and a cleaning device 5 for cleaning the stains, by the function liquid, of the waste function liquid storing member 4 which is described in more detail hereinafter. Each of these devices is respectively connected to a controller 6 which controls these devices while keeping cooperative relationship among one another.

Though not illustrated, the liquid droplet ejection apparatus 1 is provided with: a workpiece recognition camera for image-wise recognition of the workpiece W (i.e., recognizing the workpiece W in the form of images); a head recognition camera for image-wise recognition of the head unit 11 (ejection nozzles 23); and auxiliary devices such as various indicators, or the like. They are all connected to the controller 6.

This liquid droplet ejection apparatus 1 ejects the function liquid which contains therein the function material, toward the surface of the workpiece W while performing the scanning of the head unit 11 of the function liquid droplet ejection device 2 relative to the workpiece W which is set on the mounting device 3. In this manner, the film member of the function material is formed on the surface of the workpiece W to thereby coat the workpiece W with the function material. In this liquid droplet ejection apparatus 1, in order to uniformly coat the entire surface of the workpiece W with the function material, the head unit 11 ejects the function liquid uniformly on any portion of the workpiece W. Namely, the head unit 11 ejects the function liquid droplet even toward the edge portion or portions of the workpiece W in the same manner as it does toward the central portion of the workpiece W. If the function liquid droplet is ejected toward the edge portion of the workpiece W in the same manner as the one toward the central portion of the workpiece W, the function liquid droplet will result in ejection in excess of the edge (or beyond the edge) of the workpiece W to a certain degree. In order to receive the function liquid that is ejected beyond the edge of the workpiece W (also referred to as oveflown function liquid), there is provided a waste function liquid storing member 4 for receiving and storing therein the overflown function liquid. Since the function liquid is ejected in an overflown manner, i.e., ejected beyond the edge of the workpiece W, strict positioning or alignment of the workpiece W is no longer required.

The function liquid droplet ejection device 2 is made up, as shown in FIG. 1, of: a head unit 11 on which are mounted function liquid droplet ejection heads 21; a main carriage 13 which supports the head unit 11 in suspension; and an X-Y moving mechanism 14 which is capable of moving the workpiece W in a main scanning direction (X-axis direction) through the mounting device 3 and which is also capable of moving the head unit 11 in the subsidiary scanning direction (also referred to as a sub-scanning direction, which is in the Y-axis direction).

The head unit 11 is made up of: a plurality of function liquid droplet ejection heads 21; and a carriage 12 on which are mounted the function liquid droplet ejection heads 21. The function liquid droplet ejection heads 21 is made up of: a sub-carriage mounting part (not illustrated) which is provided with a head substrate and a function liquid introduction part; and a head main body which is provided with ejection nozzles 23 for ejecting the function liquid. On the nozzle surface 24 of the head main body, there are formed two rows of nozzle arrays each being made up of a plurality of ejection nozzles 23. The function liquid droplet ejection heads 21 are mounted on (or fixed to) the sub-carriage 12 so that the nozzle surface 24 protrudes downward.

The sub-carriage 12 is provided with two rows of mounting openings (not illustrated) for mounting therein the function liquid droplet ejection heads 21. Each row has formed therein six mounting openings. In other words, respective rows of mounting openings have six function liquid droplet ejection heads 21, and the sub-carriage 12 has mounted thereon twelve function liquid droplet ejection heads 21 in total. The mounting openings function to align the mounting position of each of the function liquid droplet ejection heads 21. In order to dispose each of the function liquid droplet ejection heads 21 so that a sufficient coating density can be secured relative to the workpiece W, the mounting openings are formed at a predetermined angle to the main scanning direction. The number of, and the disposition of, the function liquid droplet ejection heads 21 are arbitrary and, therefore, may be set to suit the actual conditions considering the kind, or the like, of the workpiece W. For example, the function liquid droplet ejection heads 21 may be disposed in a staggered manner or in a stepwise manner.

The main carriage 13 is made up of: a carriage main body (not illustrated) which supports the head unit 11 in a suspended manner; and a head bracket (not illustrated) which supports the carriage main body and which is supported by a Y-axis table 16 (to be described hereinafter) in a manner slidable in the sub-scanning direction (Y-axis direction). The carriage main body is arranged to be rotatable in a Θ-axis direction (i.e., rotatable about a Θ axis). By rotating the carriage main body in the Θ-axis direction, the position of the nozzle surface 24 of the head main body can be adjusted to a suitable position. This adjustment in the Θ-axis direction is carried out based on the recognized image of a head recognition camera (not illustrated).

The X-Y moving mechanism 14 is made up of: an X-axis table 15 which supports the mounting device for mounting the workpiece W thereon; and a Y-axis table 16 which crosses the X-axis table 15 at right angles and which supports the head unit 11 through the head bracket. In order to adequately eject the function liquid droplet toward the surface of the workpiece W, the X-Y moving mechanism 14 alternately moves the head unit 11 and the workpiece W in a manner synchronized with the driving of the function liquid droplet ejection head 21. In other words, in this liquid droplet ejection apparatus 1, the movement of the workpiece W in the main scanning direction (X-axis direction) by means of the X-axis table 15 and the movement of the head unit 11 in the sub-scanning direction (Y-axis direction) by means of the Y-axis table 16 are repeated. The function liquid is ejected at the time of movement of the workpiece W in the main scanning direction, whereby the film member of the function material is formed over the entire surface of the workpiece W.

In this embodiment, the arrangement is made such that the workpiece W is moved in the main scanning direction and the head unit 11 is moved in the sub-scanning direction. However, an arrangement is acceptable as long as a relative scanning is made between the head unit 11 and the workpiece W. It means that the head unit 11 may be arranged to move in the main scanning direction. An arrangement may also be made that the workpiece W is fixed and that the head unit 11 is moved in the main scanning direction and in the sub-scanning direction.

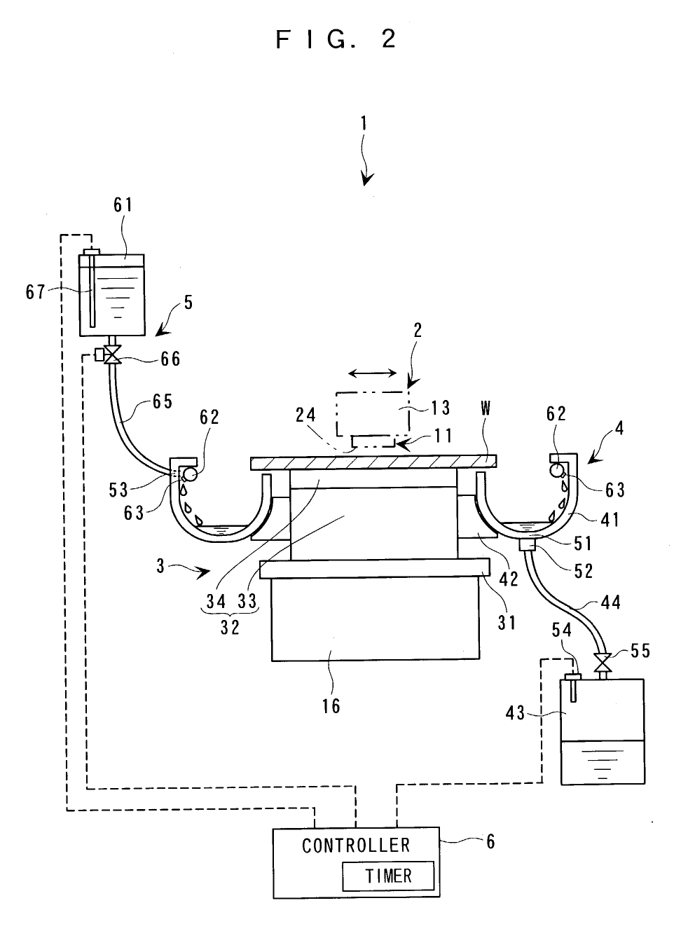

A description will now be made about the mounting device 3. As shown in FIG. 2, the mounting device 3 has a base plate 31 which is fixed to the X-axis table 15. A Θ table for performing the correction of the workpiece W in the Θ-axis direction and a suction table 34 for setting the workpiece W in position are integrally supported on the base plate 31. In other words, a work table 32 is constituted by the Θ table 33 and the suction table 34. The base plate 31 supports the Θ table 33 so as to be rotatable in the Θ-axis direction and also supports the suction table 34 through the Θ table 33. Based on the recognition image of the workpiece recognition camera (not illustrated), the Θ table 33 can rotate in the Θ-axis direction the workpiece W which is set in position through the suction table 34. According to this arrangement, a correction in the Θ-axis direction is performed so that the workpiece W can be set in position relative to the head unit 11. The suction table 34 has formed therein a plurality of suction holes 35 so that the workpiece W can be sucked and fixed to the suction table 34 as a result of suction through the suction holes 35.

The horizontal surface of the Θ table 33 is made smaller than the workpiece W, and the horizontal surface of the suction table 34 is equal to or slightly smaller than the workpiece W. In this manner, it is so arranged that the work table 32 does not get stained by the overflown function liquid i.e., by the function liquid that is ejected beyond the edge of the workpiece W. In this embodiment, the work table 32 is shown as a rectangular parallelepepid. It may, of course, be of other shapes such as a column.

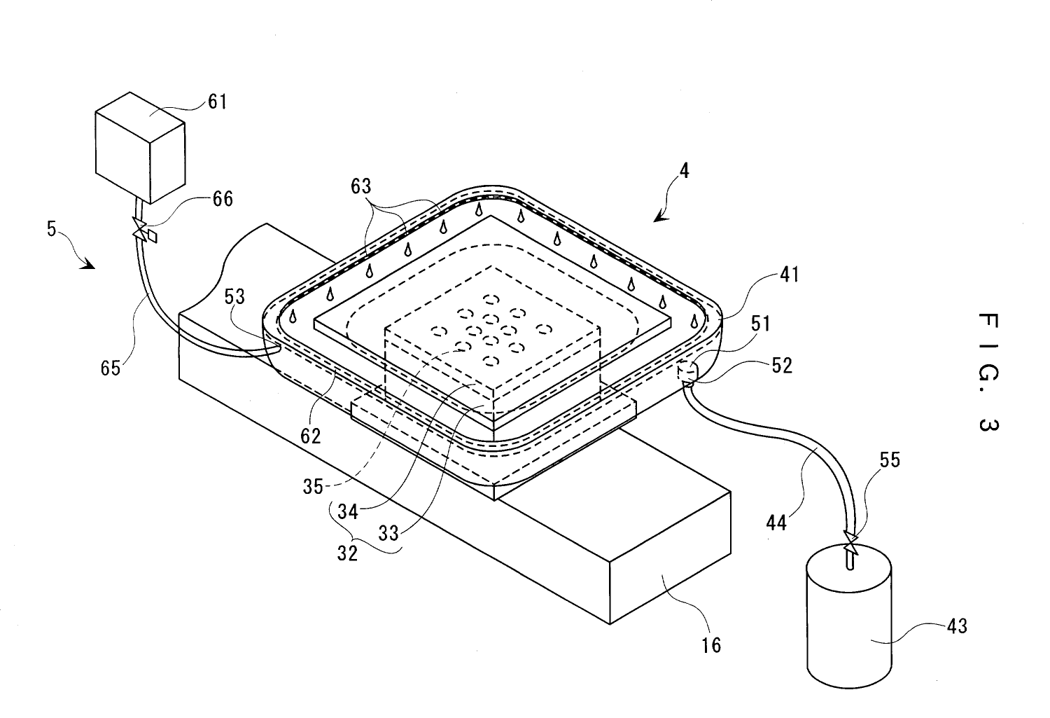

With reference to FIGS. 2 and 3, a description will now be made about the waste function liquid storing member 4 which constitutes the main part of this invention. The waste function liquid storing member 4 is made up of: a function liquid receiver 41 which receives the overflown function liquid, i.e., the function liquid that is ejected beyond the edge of the workpiece W; a plurality of supporting brackets 42 which support the function liquid receiver 41; a waste function liquid tank 43 which stores therein the function liquid that is discharged from the function liquid receiver 41; and a discharge tube 44 which connects the function liquid receiver 41 and the waste function liquid tank 43 together.

The function liquid receiver 41 is formed into a trough shape which has a substantially U-shaped cross section, and its upper outer circumference is bent inward. In order to efficiently receive the overflown function liquid that has been ejected beyond the edge of the workpiece W, the function liquid receiver 41 is formed into an annular shape (or into a substantial loop) to suit the shape of the plane of the workpiece W. The function liquid receiver 41 has at its bottom an outlet 51 for discharging the function liquid. The outlet 51 is provided with an outlet fixture 52 for connection to the discharge tube 44. On an upper end of an inner portion of the function liquid receiver 41, there is provided a connection port 53 for connecting a cleaning liquid discharge pipe 62 and a cleaning liquid supply tube 65, which are described hereinafter.

As shown in FIG. 2, the supporting brackets 42 are fixed to the side surface of the Θ table 33 of the mounting device 3. The supporting brackets 42 support the function liquid receiver 41 so that the function liquid receiver 41 formed into an annular or loop shape always faces the peripheral portion of the set workpiece W, i.e., so that the peripheral or edge portion of the workpiece W partly overlaps the function liquid receiver 41. The plurality of supporting brackets 42 are evenly disposed in the circumferential direction relative to the Θ table 33. In order to quickly discharge the function liquid received by the function liquid receiver 41, the supporting brackets 42 support the function liquid receiver 41 in a downward inclination toward the outlet 51. This downward inclination is preferably in the range of about 1/50 to 1/100.

The waste function liquid tank 43 is connected to the function liquid receiver 41 by means of a discharge tube (silicone tube) 44, and stores therein the function liquid that is received by the function liquid receiver 41 after being ejected beyond the edge of the workpiece W. The waste function liquid tank 43 is also arranged to be adequately replaced when it is filled with the function liquid. The waste function liquid tank 43 is provided with a function liquid level detector 54 which detects the state in which the waste liquid tank 43 is filled up with the waste liquid (e.g., maximum liquid level). The controller 6 controls the function liquid ejection heads 21 so that the function liquid does not overflow the waste function liquid tank 43. The waste function liquid tank 43 is made of a stainless steel, resin, glass, or the like.

The discharge tube 44 is connected at its one end to the outlet fixture 52 of the function liquid receiver 41 and is connected at the other end thereof to the waste function liquid tank 43, whereby the function liquid receiver 41 and the waste function liquid tank 43 are connected together by the tube. The discharge tube 44 is provided with a function liquid gate valve 55 which closes the flow of the function liquid from the function liquid receiver 41 to the waste function liquid tank 43.

In order to clean the function liquid receiver 41, the cleaning device 5 is made up, as shown in FIGS. 2 and 3, of: a cleaning liquid tank 61 which stores therein a cleaning liquid for dissolving the function liquid; a cleaning liquid discharge pipe 62 which discharges the cleaning liquid into the function liquid receiver 41; and a cleaning liquid supply tube 65 which connects the cleaning liquid tank 61 and the cleaning liquid discharge pipe 62 by means of a tube. The cleaning liquid tank 61 is provided with a cleaning liquid level detector 67 which detects the decrease in the cleaning liquid level (e.g., minimum liquid level) so that the decrease in the liquid level in the cleaning liquid tank 61 can be detected.

The cleaning liquid discharge pipe 62 is connected to a connecting port 53 which is provided in an upper periphery of the function liquid receiver 41, and is disposed along an inner side of the bent portion of the function liquid receiver 41. The cleaning liquid discharge pipe 62 is connected to the cleaning liquid supply tube 65 (silicone tube) through the connecting port 53 and is connected to the cleaning liquid tank 61 by means of the cleaning liquid supply tube 65. The cleaning liquid discharge pipe 62 is provided with a plurality of cleaning liquid discharge holes 63 substantially at an equal distance from one another so that the cleaning liquid can be uniformly discharged toward the function liquid receiver 41. Each of the cleaning liquid discharge holes 63 faces toward the inner surface of the outer side wall of the function liquid receiver 41 so that the cleaning liquid can be efficiently discharged toward the inner upper portion of the outer side wall of the function liquid receiver 41.

The cleaning liquid supply tube 65 is connected at its one end to the cleaning liquid tank 61 and is connected at the other end thereof to the connection port 53 of the function liquid receiver 41, whereby the cleaning liquid tank 61 and the cleaning liquid ejection pipe 62 are connected together by means of a pipe through the connection port 53. In order to perform the cleaning of the function liquid receiver 41 at a regular time interval, there is provided, on an upstream end of the cleaning liquid supply tube 65, a solenoid valve 66 which is connected to the controller 6. The solenoid valve 66 is so controlled as to be opened and closed at every predetermined time interval. The solenoid valve 66 may also be controlled not by a timer but by a manual operation.

Each of the above-described devices of the liquid droplet ejection is controlled by the controller 6 which, in turn, controls the entire liquid droplet ejection apparatus 1 so that the function liquid can be ejected toward the workpiece W under predetermined conditions.

For example, once the waste function liquid tank 43 becomes full of the function liquid, the function liquid level detector 54 detects the state in which the waste function liquid tank 43 is full, and transmits a signal to the controller 6 to the effect that the tank is full. Then, the controller 6 causes an indicator lamp (not illustrated) to be lighted up to thereby indicate that the waste function liquid tank 43 is full. The function liquid droplet ejection device 2 is then stopped immediately or, alternatively, after the thin film formation on the workpiece W which is on the way (or in the course) of thin film formation has been completed. In this manner, the function liquid is prevented from overflowing from the waste function liquid tank 43. The fully-occupied waste function liquid tank 43 is replaced. Once the signal of full-liquid state ceases to be detected, the controller 6 puts off the indicator lamp which is used to show the fully-occupied state of the waste liquid tank 43 and the function liquid droplet ejection device 2 is operated again. In this embodiment, the fully-occupied state of the waste function liquid tank 43 is reported by the indicator lamp. It is, however, not limited to the indication by means of the indicator lamp, but may also be made by means of a audible signal, or the like.

Similarly, the controller 6 also indicates by switching on a cleaning liquid level indicator (not illustrated) based on a cleaning liquid level decrease signal from the cleaning liquid level detector 67 that operates to detect a decrease by a predetermined amount in the cleaning liquid in the cleaning liquid tank 61.

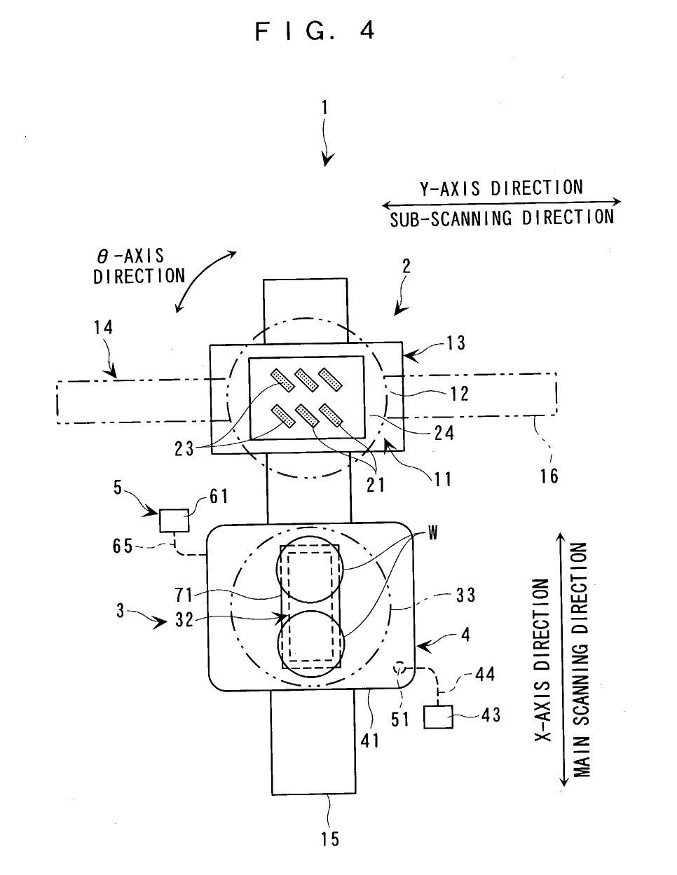

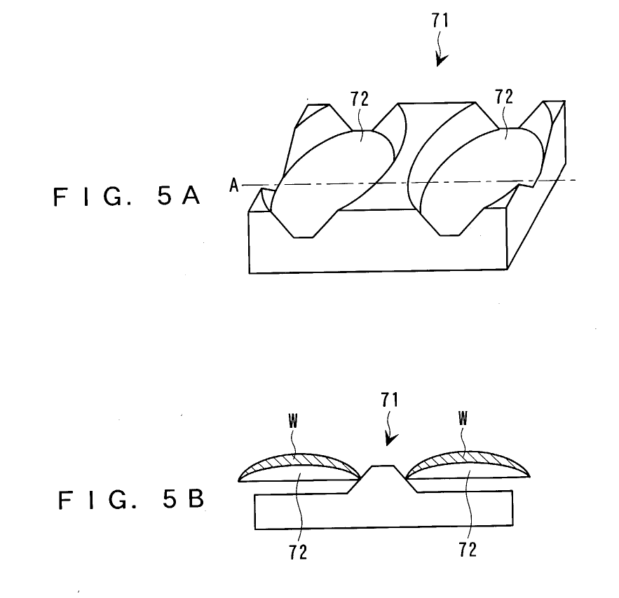

With reference to FIGS. 4 and 5, a description will now be made about the second embodiment of this invention. The following description will basically be made about what is different from the above-described first embodiment. The same or similar elements have assigned thereto the same reference numerals as those in the first embodiment. In this second embodiment, the workpiece W is made up of a pair of lenses for use in a pair of eyeglasses (hereinafter also referred to as eyeglass-lenses for simplicity). The workpieces W are set in position on the work table 32 through a tray 71 so as to facilitate the setting of curved eyeglass-lenses onto the work table 32.

As shown in FIGS. 5A and 5B, the tray 71 has formed therein two recessed portions 72 which serve as setting portions into which the workpieces W are set in position. In view of the fact that two lenses are handled as one set for use in a pair of eyeglasses, it is so arranged that two workpieces W in one set can be positioned on the tray 71. Since the eyeglass-lenses as the workpieces W are circular in plan view and are curved as seen in side view, each of the recessed portions 72 is formed to suit them, i.e., into a shape which is substantially circular in plan view. In addition, each of the recessed portion 72 is formed into an inclined surface, i.e., the central portion thereof is formed the highest as seen in cross section, gradually declining in all radially outward directions. The tray 71 is formed in substantially rectangular as seen in plan view and the length of each of the shorter sides of the rectangle is arranged to be smaller than the diameter of the workpiece W. It is thus so arranged that the edge portions of each of the workpieces W protrude or project outward beyond the corners of the tray 71. By setting the workpieces W in position onto the tray 71 so as to allow the edge portions of the workpieces W to protrude beyond the corners of the tray 71 as described above, the setting of the workpieces W onto the tray 71 becomes easy and the handling of the set workpieces W becomes easy.

The tray 71 to be used in this embodiment is arranged to receive thereon a pair of workpieces W. It may, of course, be arranged that a single piece of workpiece W is set in position on a single piece of tray 71. In addition, in this embodiment, the bottom portion of the recessed portion 72 is formed into an inclined surface so that the central portion is the highest as seen in cross section to thereby gradually decline in radially outward directions. It may alternatively be so arranged that at least three pins of the same length are disposed on the bottom surface of the recessed portion 72 so that they can serve as the supports to align and hold the workpiece W in position.

The mounting device 3 of this embodiment has the similar construction as that in the first embodiment. However, in this embodiment, the workpieces W are mounted on, or set in position on, the work table 32 (suction table 34) through the tray 71 unlike in the first embodiment in which the workpieces W are directly placed on the work table 32. In addition, in the first embodiment, the horizontal plane of the work table 32 (Θ table and suction table 34) do not protrude beyond the workpiece W. In this embodiment, on the other hand, the horizontal plane of the work table 32 (Θ table and the suction table 34) is arranged not to protrude beyond the tray 71 on which the workpiece W is placed. In other words, the work table 32 is arranged to have a smaller horizontal plane than the horizontal plane of the tray 71.

The waste function liquid storing member 4 has also the similar construction as that of the first embodiment. As shown in FIG. 4, the function liquid receiver 41 is formed into a substantially loop shape to suit the shape in plan view not only of the workpiece W but also of the tray 71. The function liquid receiver 41 is supported in such a manner that the function liquid receiver 41 partly overlaps the edge portions of the tray 71 which is set in position on the work table 32 (suction table 34) as well as the edge portions of the two workpieces W. Therefore, even if the driving operation of the function liquid droplet ejection head 21 is performed beyond the edges of the workpieces W, the function liquid that has been ejected beyond the edges of the workpieces W can be received by the function liquid receiver 41. The inside of the apparatus for forming the film member can thus be prevented from getting stained with the overflown function liquid.

In the same manner as in the first embodiment, the function liquid receiver 41 has formed therein a discharge port 51. The function liquid receiver 41 is supported at a downward inclination toward the discharge port 51. It is thus so arranged that the function liquid received in the function liquid receiver 41 and the cleaning liquid discharged toward the function liquid receiver 41 can be quickly discharged out of the discharge port 51. In case the function liquid is ejected beyond the edges of the workpiece W, the tray 71 on which the workpieces W are placed gets stained with the function liquid. The stained tray 71 can, however, be cleaned by the cleaning liquid after the completion of the coating on the workpieces W. The function liquid can thereafter be reused.

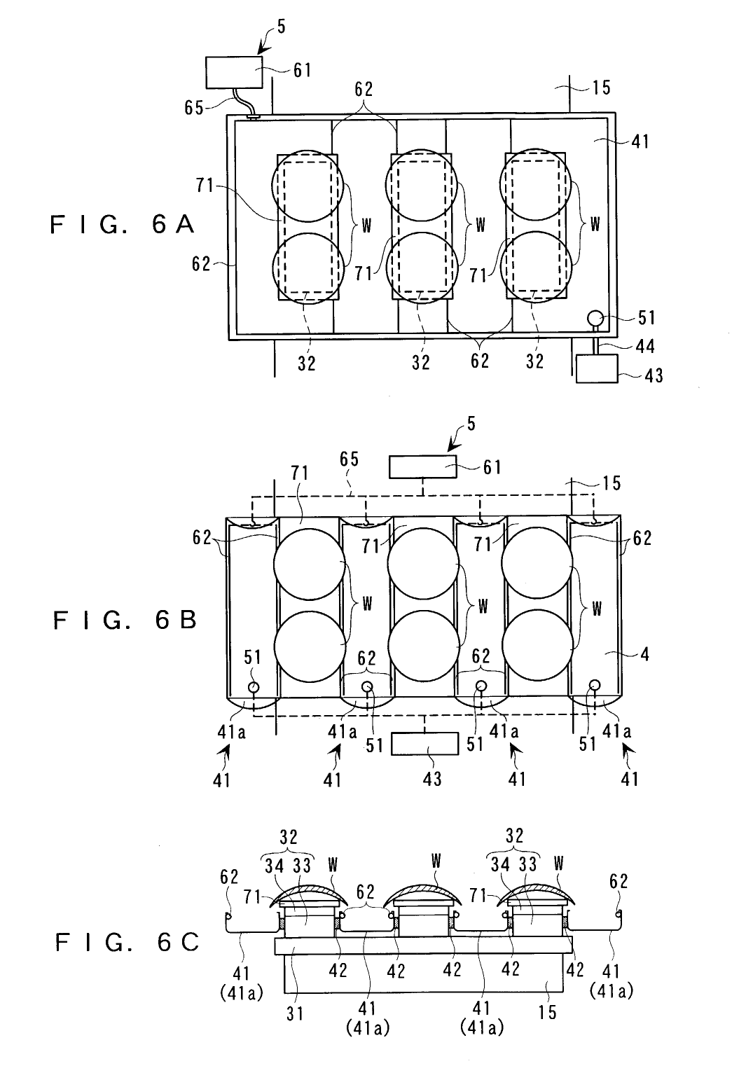

With reference to FIGS. 6A through 6C, a description will now be made about a third embodiment of this invention. This embodiment is substantially the same as that of the second embodiment except for the following point. Namely, while in the second embodiment a single tray 71 having set thereon the workpieces W is set for processing by coating one set of the workpieces set on the single tray 71, this embodiment is different in that a plurality of (three in this case) trays 71 are set for processing plurality sets (three sets in this case) at the same time.

As shown in FIG. 6C, the mounting device 3 has the base plate 31 which is fixed to the X-axis table 15. On the base plate 31 there are disposed a plurality of (three in this case) work tables 32 each of which is made up of the Θ table 33 and the suction table 34. The horizontal plane of each work table 32 is made slightly smaller than the tray 71 so as not to protrude beyond the tray 71.

The waste function liquid storing member 4 has also the similar construction as that of the second embodiment except for the following point. Namely, the waste function liquid receiver 41 of this embodiment is formed to suit the shape of the tray 71 as seen in plan view and the lay out of each of the work tables 32. In concrete, as shown in FIG. 6A, the function liquid receiver 41 is not only formed into a substantially loop shape but also is formed to enclose the entire work tables 32 so that the function liquid that has been ejected between the work tables 32 can be received by the function liquid receiver 41. In other words, the function liquid receiver 41 is disposed also between the work tables 32 to thereby receive all the function liquid that has been ejected beyond the workpieces W.

The function liquid receiver 41 is not only substantially in U shape in cross section but also is bent inward at the upper end portion. The function liquid receiver 41 is supported by the supporting bracket 42 such that the bent portion on the side which is fixed to the work table 32 is positioned inward of the tray 71. The function liquid that has been ejected beyond the workpieces W can thus be prevented from adhering to the bent portion.

The cleaning device 5 has also the similar construction as that of the second embodiment except for the following point. Namely, as shown in FIG. 6A, the cleaning liquid discharge pipe 62 is laid out not only along the loop portion of the function liquid receiver 41 but also along the function liquid receivers 41 disposed between each of the work tables 32. In the loop portion of the function liquid receiver 41 there is disposed the cleaning liquid discharge pipe 62 in the same manner as in the above-described embodiment. For use by the function liquid receiver 41 between each of work tables 32, the cleaning liquid discharge pipe 62 is laid out along inner upper portions of both the bent portions, respectively. Although not illustrated, each of the cleaning liquid discharge holes 63 are directed toward the wall side of the function liquid receiver 41 so that the function liquid adhered to the function liquid receiver 41 can be efficiently cleaned.

A description will now be made about a fourth embodiment of this invention. This has substantially the similar construction as that of the third embodiment. A plurality of (three in this case) trays 71 are set so that the coating processing can be performed at the same time to a plurality of (three sets in this case) workpieces W. The trays 71 to be used in this embodiment is substantially the same as that in the above-described one except for the following point. Namely, the trays 71 used in the second and third embodiments are constructed such that the workpieces W protrude beyond the four sides of the trays 71 which are rectangular in shape as seen in plan view. As shown in FIG. 6B, the tray 71 of this embodiment, on the other hand, is constructed such that the workpieces W are set in position such that the workpieces W protrude only beyond one set of longer sides respectively.

As shown in FIG. 6B, the function liquid receivers 41 of the waste function liquid storing member 4 are disposed along those longer sides of the tray 71 beyond which the tray 71 protrude, such that the function liquid that has been ejected beyond the tray 71 and the workpieces W can be received. Each of the function liquid receivers 41 is constituted by a trough-shaped member 41a which has a substantially U shape in cross section and which is formed to suit the length of the longer side of the tray 71. Each of the trough-shaped members 41a is disposed, through the supporting brackets 42, along the longer sides of the tray 71 at an inclination. Each of the trough-shaped members 41a has formed a discharge port 51 in the bottom near the lower end and a connection port 53, at an upper end thereof, for connecting the cleaning liquid discharge pipe 62 and the cleaning liquid supply tube 65 together. The discharge tube 44 connected to the waste liquid tank 43 is connected to each of the discharge ports 51 through branching.

The construction of the cleaning device 5 is also substantially the same as that of the above-described embodiment except for the following point. Namely, the cleaning liquid discharge pipe 62 whose one end is connected to the connecting port 53 of each of the trough-shaped members 41a is divided into two near the connecting port 53 so as to be laid down along the inner wall surface at an upper end of the trough-shaped member 41a. In other words, the function liquid receiver 41 of this embodiment has disposed therein a total of eight cleaning liquid discharge pipes. The cleaning liquid supply tube 65 connected to the cleaning liquid tank 61 is branched into four so as to be tied into each of the connection ports 53, whereby the cleaning liquid tank 61 and the cleaning liquid discharge pipe 62 are connected together.

In this manner, according to the liquid droplet ejection apparatus 1 of the second through the fourth embodiments, the function liquid that has been ejected beyond the edges of the tray 71 can be received by the function liquid receiver 41, whereby the inside of the apparatus is prevented from getting stained by the function liquid. In other words, it becomes possible to drive the function liquid droplet ejection head 21 already at a point where the head unit 11 reaches the workpieces W. It follows that the function liquid can be ejected toward the edge portions of the workpieces W in the same manner as toward the central portion thereof, whereby the workpieces W can be uniformly coated with the film member over the entire surfaces thereof without leaving a part thereof uncoated.

The liquid droplet ejection apparatus according to this invention can be applied to the forming of the coating of eyeglass-lenses, the coating of various optical lenses, as well as to the manufacturing of various flat display panels, or the like. Now, a description will be made about a method of manufacturing by using this liquid droplet ejection apparatus, with reference to the method of manufacturing a liquid crystal display device and the method of manufacturing an organic electroluminescence (EL) device.

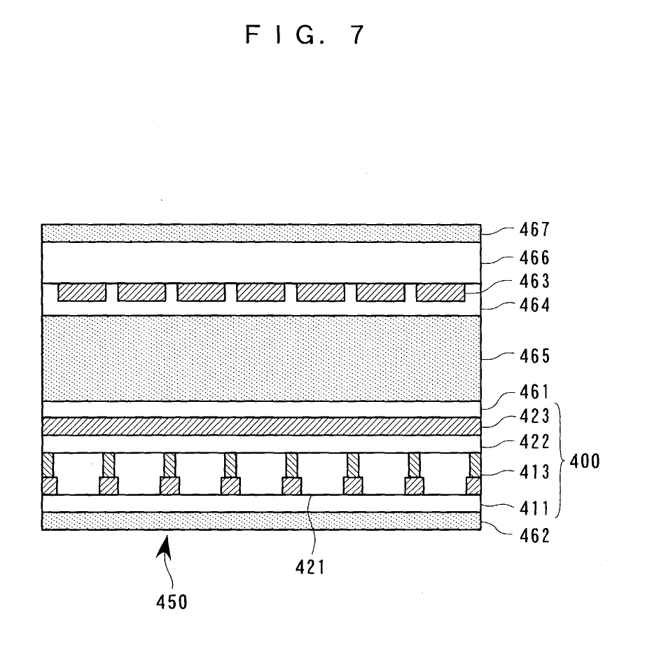

FIG. 7 is a sectional view of a liquid crystal display device. As shown therein, the color liquid crystal display device 450 is made up of upper and lower deflector plates 462, 467; a color filter 400 and a counter (opposite) substrate 466 which are interposed between the deflector plates 462, 467; and a liquid crystal composition 465 sealed between the color filter 400 and the counter substrate 466. Orientation films 461, 461 are formed between the color filter 400 and the counter substrate 466. On the inner surface of the counter substrate 466, there are formed thin film transistor (TFT) elements (not illustrated) and pixel electrodes 463 in the form of a matrix.

The color filter 400 is provided with pixels (filter elements) arranged in the form of a matrix, and the border between the respective pixels is partitioned by a partition (bank) 413. Each of the pixels has introduced therein a liquid material (filter material) of red (R), green (G) or blue (B) color. In other words, the color filter 400 is provided with a translucent substrate 411 and a light blocking partition 413. The portions in which the partitions 413 are not formed constitute the above-described pixels. The liquid material of each of the above-described colors constitutes the colored layer 421. An overcoat layer 422 and an electrode layer 423 are formed on the partition 413 and the colored layer 421.

In this embodiment, each of the liquid material of red, green and blue colors is introduced by a liquid droplet ejection method into each of the pixels partitioned by the partitions 413. In other words, by means of the function liquid droplet ejection heads 9, the droplets of each of the red, green and blue colors are selectively ejected into the respective colored layer forming regions. Then, the coated or ejected liquid material is dried to thereby obtain the colored layer 421. Similarly, the overcoat layer 422 is formed by the liquid droplet ejection method.

In this embodiment, in forming the colored layer 421, the angle of inclination of the function liquid droplet ejection heads 9 is adequately made variable so that the pitch of each of the ejection nozzles 23 and the pitch of the pixels coincide with each other. In forming the overcoat layer 422, the angle of the inclination of the function liquid droplet ejection heads 21 is adequately varied to thereby adjust the film thickness of the layer.

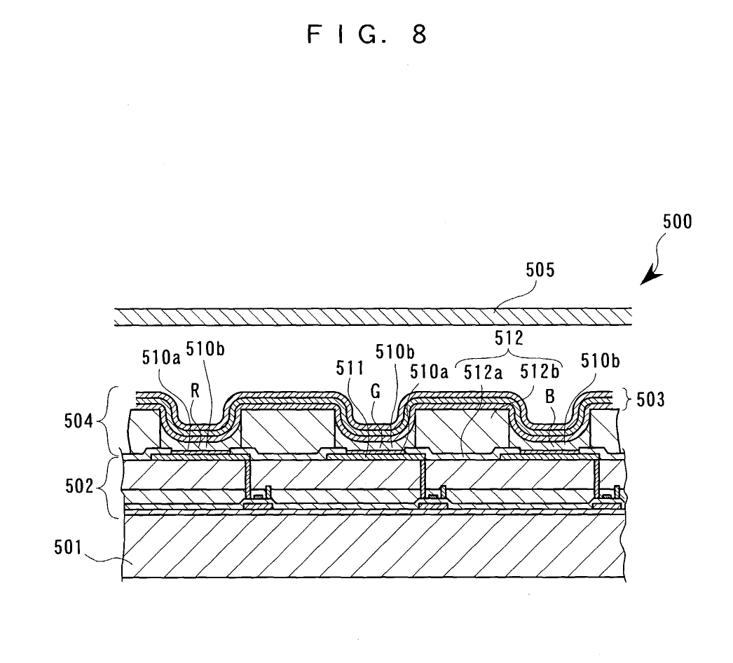

A description will now be made about the method of manufacturing an organic electroluminescence (EL) device with reference to FIG. 8. As shown therein, the organic EL device 500 is made up of a glass substrate 501 and a circuit element 502 which is laminated on top of the glass substrate 501. An organic EL element 504 which forms the main part is laminated on top of the circuit element 502. On top of the organic EL element 504, there is formed a sealing substrate 505 while leaving a space for an inert gas therebetween.

The organic EL device 504 has formed therein a bank 512 which is made up of a bank layer 512a of an inorganic matter and a bank layer 512 of an organic matter. A matrix of pixels are defined by the bank 512. Each of the pixels has laminated therein, from the bottom upward, the pixel electrode 511, the light emitting layer 510b of red, green or blue, and the hole injection/transport layer 510a. The entire surface is then covered by the counter electrode 503 which has laminated therein a plurality of thin films of calcium (Ca), aluminum (Al), or the like.

In this embodiment, the light emitting layer 510b of red, green and blue as well as the hole injection/transport layer 510a are formed by the liquid droplet ejection method. After the hole injection/transport layer 510a has been formed, the counter electrode 503 is formed in the similar manner by the liquid droplet ejection method by using the liquid metallic material of Ca, Al or the like. In case the sealing substrate 505 is alternatively sealed by a resin having high sealing characteristics, it is preferable to eject the resin by a liquid droplet ejection method.

In this embodiment, the angle of inclination of the function liquid droplet ejection heads 21 is adequately made variable in forming the light emitting layer 510b and the hole injection/transport layer 510a so that the pitch of each of the ejection nozzles 23 and the pitch of the pixels coincide with each other. The angle of inclination of the counter electrode 503 is adequately made variable in forming the counter electrode 503 so that the film thickness can be adjusted.

As described hereinabove, according to the film forming apparatus, method of forming lenses, method of forming color filters and method of forming organic EL device of this invention, the trough-shaped receiving member prevents the inside of the apparatus from getting stained with the function liquid that has been ejected beyond the edge portion of the workpiece. Therefore, the function liquid can be coated to the edge portion of the workpiece in the same manner as in the central portion thereof by ejecting the function liquid even to the edge portion thereof. It is thus possible to uniformly coat the workpiece with the function liquid without the occurrence of portions left uncoated. Further, the function liquid that has dropped into the trough-shaped receiving member is stored in the waste function liquid storing member and, when the waste function liquid storing member becomes full of the function liquid, the waste function liquid storing member may be replaced or only the stored waste function liquid may be disposed of. Therefore, the easy and efficient maintenance of the apparatus become possible. Still furthermore, since the function liquid is ejected beyond the edge of the workpiece W, it is not necessary any more to strictly align the position of placing the workpiece W. As a result, the apparatus becomes simpler in construction and the time which was formerly required for alignment of the workpiece W can be reduced. The productivity can thus be improved.

What is claimed is:

1. An apparatus for forming a film member, comprising:
a first means for ejecting a function liquid droplet beyond an edge of a workpiece by performing relative scanning between the workpiece and a function liquid droplet ejection head having introduced therein a function liquid;
a second means for receiving the function liquid ejected beyond the edge of the workpiece; and
a third means for storing a waste function liquid discharged from said second means.

2. An apparatus for forming a film member on a surface of a workpice, comprising:
a first means for performing relative scanning between the workpiece and a function liquid droplet ejection head having introduced therein a function liquid, said scanning being made beyond an edge of the workpiece;
a second means for selectively ejecting a function liquid droplet from said function liquid ejection head during scanning by said first means;
a third means for receiving the function liquid ejected beyond the edge of the workpiece; and
a fourth means for storing a waste function liquid discharged from said second means.

3. An apparatus for forming a film member on a surface of a workpice,
wherein relative scanning is performed between the workpiece and a function liquid droplet ejection head having introduced therein a function liquid such that the function liquid is ejected beyond an edge of the workpiece, said apparatus comprising:
a trough-shaped receiving member which receives the function liquid to be ejected from said function liquid droplet ejection head beyond the edge of the workpiece; and
a waste function liquid storing member which is connected by a pipe to a downstream side of said trough-shaped receiving member and which stores therein the function liquid discharged from said trough-shaped receiving member.

4. The apparatus according to claim 3, wherein said trough-shaped receiving member is formed into a U shape in cross section.

5. The apparatus according to claim 3, wherein said trough-shaped receiving member is formed into a loop in which an upper open portion of the trough-shaped receiving member faces the edge of the workpiece.

6. The apparatus according to claim 3, wherein said trough-shaped receiving member has a discharge slope toward a downstream end thereof.

7. The apparatus according to claim 6, wherein the slope is in a range of about 1/50 to 1/100.

8. The apparatus according to claim 3, wherein said trough-shaped receiving member is fixed to a work table on which the workpiece is placed.

9. The apparatus according to claim 3, further comprising a cleaning means which cleans an inside of the trough-shaped receiving member.

10. The apparatus according to claim 9, wherein said cleaning means comprises a cleaning tank which stores therein a cleaning liquid and which is connected by a pipe to an upstream end of said trough-shaped receiving member.

11. The apparatus according to claim 9, wherein said cleaning means further comprises a cleaning liquid discharge pipe which is connected to said cleaning liquid tank and which is laid along an upper inside of said trough-shaped receiving member, and wherein said cleaning liquid discharge pipe has a plurality of discharge holes for discharging the cleaning liquid therethrough.

12. The apparatus according to claim 11, wherein said cleaning liquid discharge pipe is laid out along an inner upper portion of an outer side wall of said trough-shaped receiving member.

13. The apparatus according to claim 11, wherein each of the discharge holes discharges the cleaning liquid toward an inner upper portion of an outer side wall of said trough-shaped receiving member.

14. The apparatus according to claim 3, further comprising:
function liquid level detecting means which detects a level of said waste function liquid storing member; and
control means which controls discharge operation of said function liquid droplet ejection head,
wherein said control means stops the discharge operation of said function liquid droplet ejection head when said function liquid level detecting means detects a fully stored state of said waste liquid storing means.

15. The apparatus according to claim 14, wherein said control means stops the discharge operation of said function liquid droplet after completion of forming a thin film on the workpiece if the thin film formation is still on a way.

16. A method of manufacturing a lens for forming a coating film on a surface of the lens by using the apparatus for forming a film member according to claim 3, comprising:
introducing a translucent coating material, which serving as the function liquid, into said function liquid droplet ejection head; and
performing relative scanning between said function liquid droplet ejection head and the surface of the lens, thereby ejecting the coating material to form the coating film.

17. The method according to claim 16, wherein the lens is for use with a pair of eyeglasses.

18. The method according to claim 16, wherein the lens is made up of a pair of eyeglass-lenses which are set in position on a tray.

19. A method of manufacturing a color filter, said color filter being made by arranging filter elements on a substrate, which serves as the workpiece, by using the apparatus for forming a film member according to claim 3, comprising:
introducing, after the filter element is formed, a translucent coating material, which serves as the function liquid, into said function liquid droplet ejection head; and
performing relative scanning between said function liquid droplet ejection head and the substrate, thereby ejecting the coating material to form an overcoat film.

20. A method of manufacturing an organic EL device by using the apparatus for forming a film member according to claim 3, said EL device being made by arranging pixels inclusive of EL light emitting layers on a substrate, comprising:
introducing, after the EL light emitting layers is formed, a liquid electrode material, which serves as the function liquid, into said function liquid droplet ejection head; and
performing relative scanning between said function liquid droplet ejection head and the substrate, thereby selectively ejecting the liquid electrode material to form a counter electrode film.
